(19) United States
(12) Patent Application Publication
(10) Pub. No.: US 2002/0070158 A1
(43) Pub. Date: Jun. 13, 2002

(54) MEMBRANE ELEMENT AND PROCESS FOR ITS PRODUCTION

(76) Inventors: KLAUS BUECHER, WIESBADEN (DE); ULRICH MEYER-BLUMENROTH, IDSTEIN (DE); KLAUS NOLL, BAD CAMBERG (DE); TODD REUS, NIEDERNHAUSEN (DE)

Correspondence Address: FOLEY AND LARDNER, 3000 K STREET NW SUITE 500, WASHINGTON, DC, 200075109

(21) Appl. No.: 09/329,258

(22) Filed: Jun. 10, 1999

(30) Foreign Application Priority Data
Jun. 12, 1998 (DE) 198 26 161.6

(51) Int. Cl. B01D 63/00

(52) U.S. Cl. 210/321.74; 210/321.83; 210/493.4

(57) ABSTRACT

The invention relates to novel membrane elements, a process for their production and their use as filters, for example for ultrafiltration, nanofiltration, reverse osmosis, gas separation or pervaporation. The invention relates in particular to a membrane element comprising a core 9 and a sheath which encapsulates the core, where the sheath is formed from polymer films 10 which overlap one another at least to some extent and have been fused to one another in the overlap area.

The invention relates to novel membrane elements, a process for their production and their use as filters or separators, for example for ultrafiltration, nanofiltration, reverse osmosis, gas separation or pervaporation.

For the purposes of the invention, membrane elements are devices in which the membranes which carry out the actual function of separation or retention—and which are usually very fragile—have been arranged in such a way as to withstand operating conditions which are frequently severe.

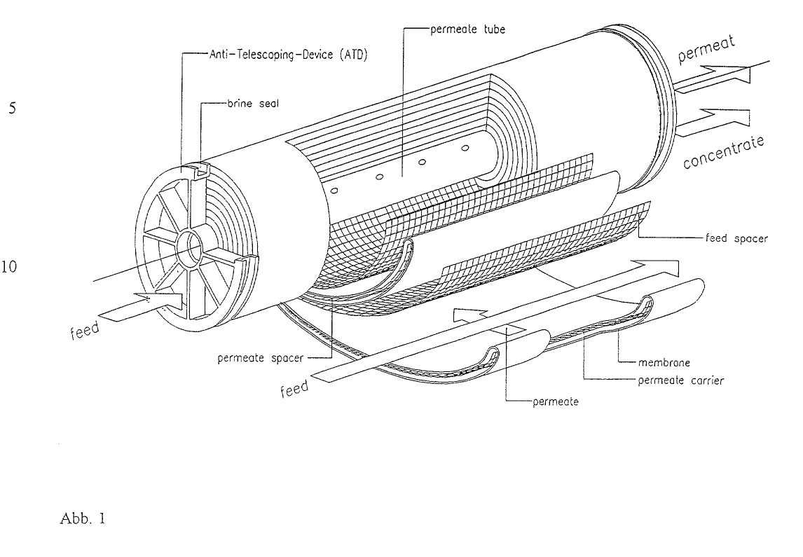

Membrane elements may have various structures. Those known as spirally wound elements are widely used. They are composed of one or more doubled layers of membrane 1 with their active separating layers facing outward. These double layers are in each case bonded or fused to one another on three sides, forming what are known as membrane pockets. The open side is bonded to the permeate pipe 4, which has perforations or holes 7 in the region of the membrane layers. Once this has been done the inner sides of the membrane pockets are then in communication only with the permeate pipe 4. The membrane pockets are wound around the permeate pipe. A feed 2 enters at the end side of the element and passes through it axially between the membrane pockets. A suitable spacer 6 ensures good cross-flow and the best possible mixing of the feed stream at the membrane surface. A pressure difference causes permeate 5 to enter the membrane pockets from both sides. A drainage layer composed of a specific permeate spacer 3 assures good outflow to the permeate pipe, the holes 7 in which provide for outflow (see FIG. 1).

Depending on the application, the semipermeable membranes used may be micro-, ultra- or nanofiltration membranes or reverse osmosis membranes, gas separation membranes or pervaporation membranes.

Elements of this type are used in waste-water treatment, in the food and drink industry, in the pharmaceutical industry, in the production of drinking water, in the separation of gas mixtures, etc. A description of a typical structure of an element is found in R. E. Larson, et al. “Test results on FT-30 eight-inch-diameter seawater and brackish water reverse osmosis element”, Desalination 46 (1983) pp. 81/90. Another form of construction is that known as “pleated elements”. In this the membranes are laid in folds and likewise are arranged around a permeate-collecting pipe. Elements of this structure are, for example, commercially available from Daicen, Japan. Examples: MOLSEP PVO4-GN-DUY-L000 and MOLSEP PV08-VV-DUY-L000.

When elements of this type are in operation they have mostly been built into casings, also termed pressure pipes. In the case of cross-flow filtration, very large amounts of fluid frequently flow across the membrane elements in the pressure pipes. To prevent the elements deforming during operation, their ends are usually provided with what are known as anti-telescoping devices (ATD) 8 and surrounded by suitable sheaths which improve their stability. The ATDs may be firmly bonded to the membrane elements, or placed over their ends, or attached to the inside of the pressure pipe. The sheaths are frequently composed of the material also used as spacer in the membrane element, for example extruded polypropylene baskets, windings with adhesive tape (made from PVC, polypropylene or polyester) or hard shells made from glass-fibre-reinforced plastic (GFP). However, under extreme operating conditions these sheaths can frequently become unable to fulfill their functions, and are damaged or deform. For example, most sheaths produced from adhesive tapes lose their stability at temperatures above 50° C. Extruded polypropylene baskets also retain only very limited dimensional stability at elevated temperatures. Membrane elements with hard GRP shells can be attacked by relatively concentrated acids or alkalis, or by solvent contents in the feed stream. This may become noticeable, for example, through a fall in strength or through flaking of the surface. Even when operating at low levels of cross-flow (some plants use what is known as dead-end operation, with no cross-flow) the operating conditions can place the membrane elements under stress, e.g. during rinsing or cleaning or as a result of unintended operating conditions (severe change in the feed stream, high temperatures, sudden changes in pressure, various service failures, etc.).

It is also vital, for use of membrane elements in gas separation and pervaporation, to avoid deformations. Agressive components in the feed stream may likewise impair the integrity of the membrane elements here, such as extreme or undesired operating conditions (considerable change in the feed stream, high temperatures, pressure shocks, general operating errors, etc.).

The object of the present invention was therefore to provide membrane elements which do not have the disadvantages described above and which in particular have sheaths which are more stable than those of the prior art. Ideally, the membrane elements should combine the following properties:

reliable operation in contact with relatively concentrated acids and alkalis, even when combined with high temperatures (up to 100° C.)

no detachment of parts of the sheath on contact with solvents

very high mechanical stability, comparable with that of hard GRP shells, but without the disadvantages of these

sheath made from a material which is also already used in the actual membrane element.

This object is achieved by a membrane element comprising a core and a sheath which encapsulates the core, where the sheath is formed from polymer films which overlap one another at least to some extent and have been fused to one another in the area of the overlap.

The object is also achieved by a process for producing membrane elements, in which a membrane core is provided with a sheath by winding a functionalized polymer film around the membrane core, where individual layers of the polymer film overlap one another, at least in some areas, and energy is supplied to fuse the polymer films to one another at least in these areas.

The novel membrane elements do not have the disadvantages of conventional sheaths. By selecting a suitable polymer film for the sheath, reliable operation may be achieved in contact with relatively concentrated acids and alkalis, even when combined with high temperatures (up to 100° C.). In addition, it is virtually impossible for parts of the sheath to detach on contact with solvents. The sheaths produced by the process described below have very high mechanical stability, comparable with that of hard GRP shells, but without the disadvantages of these. In most cases it is possible to produce the sheath from a material which is also already used in the actual membrane element.

The polymer film web for the sheath is composed of one or more layers of a polymer film with at least one functionalized surface. More than one layer of polymer films may be built up using films of identical or different types.

Particularly suitable polymer films for the application described here are those made from polypropylene (filled, unfilled, with microvoids, or filled and with microvoids). Other suitable films are based on polyester, in particular polyethylene terephthalate (filled, unfilled, with microvoids, or filled and with microvoids). Films made from PVC are also suitable, even though their chemical/thermal stability is lower.

For the purposes of the present invention, “functionalized” means that the nature of the films is such that when energy is supplied they can fuse to one another, and “fuse” means that the materials of the two films brought into contact and supplied with energy intermix in the area of contact virtually without any discernible phase boundary, this mixing taking place only at elevated temperatures, i.e. above about 70° C., preferably above about 100° C. This may be achieved, for example, by applying a sealing layer to at least one surface, the sealing layer having a lower melting temperature than the base film. For polypropylene films this may, for example, be a C₂/C₃—, C₂/C₄—, C₃/C₄— and/or C₂/C₃/C₄— copolymer outer layer. Use may generally be made of any (thermoplastic) film in which a suitable process, e.g. coextrusion, has been used to provide at least one functionalized surface (e.g. sealing layer with a lower melting point than the base film).

The core of the membrane element may be constructed in various ways. According to the invention, preference is given to what are known as spirally wound elements. They are composed of one or more doubled layers of membrane with their active separating layers facing outward. These double layers are in each case bonded or fused to one another on three sides, and form what are known as membrane pockets. The open side is bonded to the permeate pipe, which has perforations or holes in the region of the membrane layers. The membrane pockets are then wound around the permeate pipe. It is useful to wind a spacer, such as a sheet of polypropylene net, together with the membrane pockets around the permeate pipe. The end sides of the resultant rolls are then provided with anti-telescoping devices which prevent telescoping of the wound-on membrane elements.

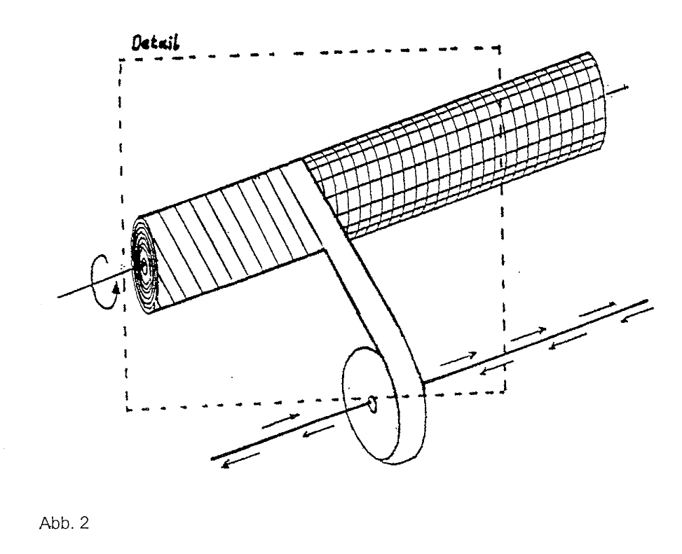

The sheath according to the invention may be applied to the core in various ways. A polymer film web 10 which has at least one functionalized surface is wound spirally around the cylindrical membrane element 9 (see FIG. 2).

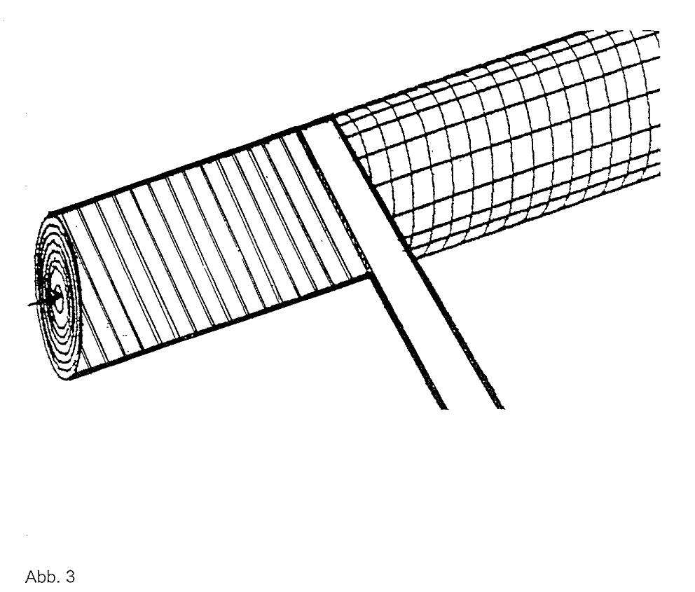

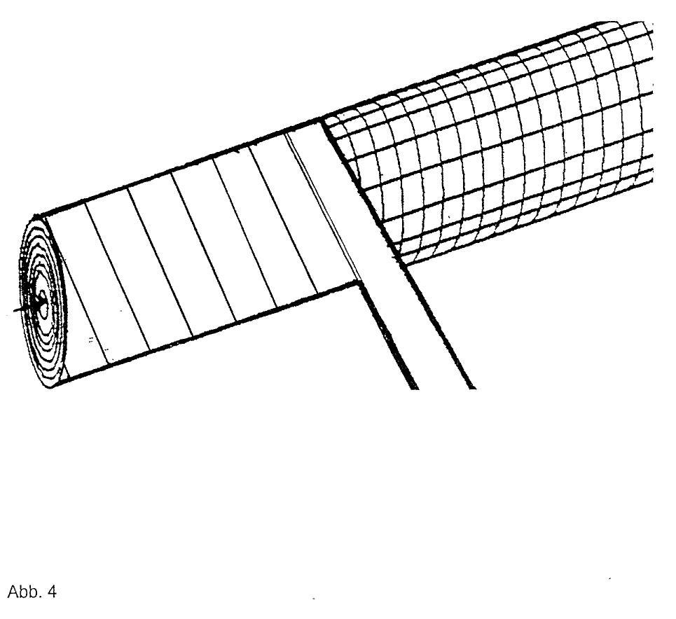

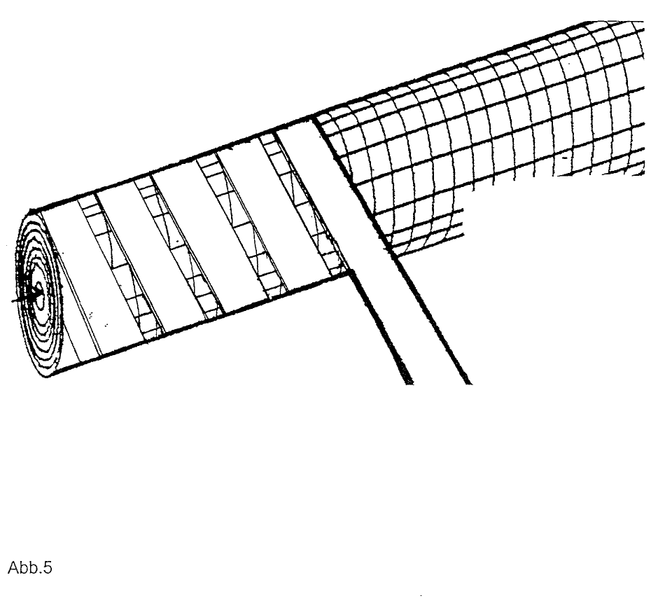

The individual windings 11a here may overlap one another fully or to some extent (FIG. 3), or lie flush and alongside one another 11b (FIG. 4), or be applied at a distance from one another 11c FIG. 5). It is useful to apply more than one layer of these windings: from 1 to 400 layers, depending on the degree of overlapping and the thickness of the polymer film web. The thickness of the sheath is from 0.3 to 28 mm.

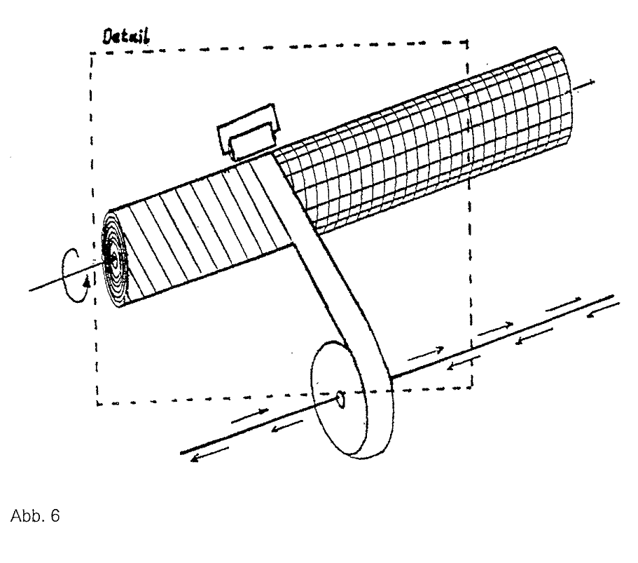

When the windings are applied, inclusion of air between the individual layers should be avoided. A suitable web tension needs to be set for this purpose. A pinch roll 12 may optionally be used (FIG. 6), in which case the force which is applied should be adjusted so that air inclusions are reliably prevented at the web tension used. The web tension may be adjusted within the range from 1N to 500N for web widths up to 100 mm and up to 1000N for a web width of about 2000 mm. Wider web widths may also be used in principle if required by the length of the membrane element. However, the maximum web width should be selected with regard to the length of the membrane element.

Depending on width and thickness, the windings of the polymer film web are applied at a speed of from 0.1 to 300 m/min.

The bond between the individual layers of the polymer film web is produced by supplying energy, preferably by suitable heat treatment.

If the heat treatment takes place during the winding-on process, it should be carried out in such a way that the functionalized surfaces produce a bond between the individual layers, and the two surfaces are preferably fused to one another in the overlap area. The polymer film web or the sheath is heated, for example, by hot air, flame, infrared radiation, microwaves, one or more hot pinch rolls, or any other suitable heat source.

During winding around the core, the polymer film web is heated in such a way as to produce the bond (fusion) immediately when the individual layers come into contact, or is heated to the extent that a small amount of further heating of the sheath causes bonding (fusion) of the individual layers. The heating process should be carried out in such a way as to avoid significant change in stability or appearance.

An alternate method of bringing about the bond between the individual layers during the winding-on process is ultrasound welding.

Another way of producing the bond is firstly to apply all of the layers of the winding and to use the heat treatment on the membrane element surrounded by the winding. Here, again, the heating may be by hot air, flame, infrared radiation, microwaves or any other suitable heat source. The heating process should be carried out in such a way as to produce a bond between all of the layers of the sheath, via their functionalized surfaces. The temperature and the exposure duration should be adjusted so that even the inner layers of the polymer film web become bonded to one another while avoiding any significant change in the stability or appearance of the outer layers which under some circumstances may be hotter (e.g. in the case of hot-air heating). This can be determined using simple experiments.

The abovementioned processes may also be combined, so that different parts of the sheath are produced by different processes. For example, a thin sheath may be applied using the last process mentioned, and this may be reinforced in a second step using the first process mentioned. The sequence may also be reversed, or one process may be replaced by the second process mentioned. The thicknesses of the sheaths produced by the respective processes may be adjusted within the range from 0.3 to 28 mm.

In the abovementioned processes windings may also be produced not only by using films with one or more layers but also by simultaneous winding-on of films with one or more layers. It is entirely possible here for the films to be different from one another.

The same applies to stepwise winding, where a first polymer film is used in a first step and other films are also used in one or more subsequent steps.

However the process is carried out, it must be ensured that the membrane of the membrane element does not become damaged anywhere on the active surface.

What is claimed is:

1. A membrane element comprising a core (9) and a sheath which encapsulates the core, where the sheath is formed from polymer films (10) which overlap one another at least to some extent and have been fused to one another in the area of the overlap.

2. A membrane element as claimed in claim 1, wherein the polymer film (10) is a polypropylene film or polyester film.

3. A membrane element as claimed in claim 1 or 2, wherein the polymer film (10) has at least one functionalized surface.

4. A membrane element as claimed in claim 1, 2 or 3, wherein the polymer film (10) is a coextruded film.

5. A membrane element as claimed in claim 4, wherein the coextruded film (10) is composed of a base layer and of at least one outer layer, where the melting point of the outer layer polymer is lower than that of the base layer polymer.

6. A membrane element as claimed in claim 5, wherein the melting point of the outer layer polymer is from 70 to 130° C.

7. A process for producing a membrane element, in which a membrane core (9) is provided with a sheath by winding a functionalized polymer film (10) around the membrane core (9), where individual layers (11) of the polymer film (10) overlap one another, at least in some areas, and energy is supplied to fuse the polymer films to one another at least in these areas.

8. The process as claimed in claim 7, wherein the polymer film (10) is wound as a layer spirally around the membrane core (9), where the individual laps of the layer (11a) overlap to some extent.

9. The process as claimed in claim 7, wherein the polymer film (10) is wound as a layer spirally around the membrane core (9), where the individual laps of the layer (11b) are laid alongside one another, without overlapping each other, and form a first layer, and where at least one further layer of polymer film (10) layers lying alongside one another is wound over the first layer, and this is then fused to the layer lying thereunder.

10. The process as claimed in claim 7, wherein the thickness of the sheath is from 0.3 to 28 mm.

11. The process as claimed in claim 8 or 9, wherein the width of the layer (10) is from 10 to 100 mm.

12. The process as claimed in claim 8 or 9, wherein the width of the layer (10) is from 100 to 2000 mm.

13. The process as claimed in claim 11, wherein the layer (10) is wound with a web tension of from 1 to 500N.

14. The process as claimed in claim 12, wherein the layer (10) is wound with a web tension of from 100 to 100N.
